(19) United States
(12) Patent Application Publication
(10) Pub. No.: US 2024/0186839 A1
(43) Pub. Date: Jun. 6, 2024

(54) WIRELESS CHARGING APPARATUS

(71) Applicant: Lanto Electronic Limited, Kunshan City (CN)

(72) Inventors: Tiehua ZHANG, Kunshan City (CN); Wenxing PAN, Kunshan City (CN); Mingcheng WANG, Kunshan City (CN); Fuqiang WANG, Kunshan City (CN)

(73) Assignee: Lanto Electronic Limited, Kunshan City (CN)

(21) Appl. No.: 18/382,679

(22) Filed: Oct. 23, 2023

(30) Foreign Application Priority Data
Dec. 6, 2022 (CN) 202211559336.2

(51) Int. Cl. H02J 50/90; H02J 7/00; H02J 50/00; H02J 50/10

(52) U.S. Cl. CPC H02J 50/90; H02J 7/0044; H02J 50/005; H02J 50/10

(57) ABSTRACT

A wireless charging apparatus includes a housing, a base, a first drive assembly, a second drive assembly and a charging coil. The housing is provided with a load-bearing cover plate, and the load-bearing cover plate is configured to carry a device to be charged. The base is disposed within the housing. The first drive assembly is disposed on the base. The second drive assembly includes a drive bracket and a moving member, the drive bracket is disposed at an output end of the first drive assembly, the output end of the first drive assembly is capable of performing a rotary motion, and the moving member is capable of performing a linear motion along an extension direction of the drive bracket. The charging coil is disposed in the moving member.

### CROSS-REFERENCE TO RELATED APPLICATION(S)

This application claims priority to Chinese Patent Application No. 202211559336.2 filed Dec. 6, 2022, the disclosure of which is incorporated herein by reference in its entirety.

### TECHNICAL FIELD

The present disclosure relates to the field of wireless charging technologies, and in particular to, a wireless charging apparatus.

### BACKGROUND

With the rapid development of electronic technology, wireless charging apparatus have been developed to meet people's growing demands for convenience. A wireless charging apparatus primarily operates on the principle of electromagnetic induction, which enables charging of a mobile phone (or other electronic devices, with mobile phones used as an example henceforth) by bringing the induction coil of the phone close to the induction coil of the wireless charging apparatus and establishing an induction charging protocol (such as the QI protocol signal of the Wireless Charging Alliance (WPC)). To cater to different types of mobile phones, a moving mechanism is designed so that the induction coil within the wireless charging apparatus can move to match the position of the induction coil in the mobile phone.

However, current wireless charging apparatus have the following main shortcomings:
1. The moving mechanism of the wireless charging apparatus can mostly only facilitate unidirectional movement of the induction coil, failing to provide full-coverage.
2. The moving mechanism of the wireless charging apparatus uses two linear modules to enable the induction coil to move in the X and Y directions. However, the linear motion structure is complex. Here, the moving components of the previous stage need to set two groups to prop up the moving components of the next stage. When the output speed of the moving components of the previous stage is inconsistent, the moving components of the next stage can get stuck, leading to a problem of immobility.

Therefore, there is an urgent need to develop a wireless charging apparatus to solve the issue of the movement structure getting stuck and becoming immobile while ensuring that the induction coil can achieve full coverage.

### SUMMARY

The present disclosure provides a wireless charging apparatus, to solve an issue that a motion structure is liable to be stuck and cannot move under the premise that the comprehensive coverage of an induction coil may be achieved.

The present disclosure adopts the following technical schemes.

The present disclosure provides a wireless charging apparatus. The wireless charging apparatus includes a housing, a base, a first drive assembly, a second drive assembly and a charging coil.

The housing is provided with a load-bearing cover plate, and the load-bearing cover plate is configured to carry a device to be charged. The base is disposed within the housing. The first drive assembly is disposed on the base. The second drive assembly includes a drive bracket and a moving member, the drive bracket is disposed at an output end of the first drive assembly, the output end of the first drive assembly is capable of performing a rotary motion, and the moving member is capable of performing a linear motion along an extension direction of the drive bracket. The charging coil is disposed in the moving member.

Optionally, the second drive assembly includes the drive bracket, a screw rod, the moving member and a first power member, where the drive bracket is rotatably disposed at the output end of the first drive assembly, the screw rod is rotatably disposed on the drive bracket, the first power member is disposed on the drive bracket and is in transmission connection with the screw rod, the moving member is provided with a screw hole, and the moving member is slidably disposed on the drive bracket and is in threaded engagement with the screw rod.

Optionally, the wireless charging apparatus includes a wire assembly, an input end of the wire assembly is located on the base, and an output end of the wire assembly is connected to the charging coil.

Optionally, the wire assembly includes a first transfer member, a second transfer member, a first arc-shaped member and a second arc-shaped member, where the first arc-shaped member and the second arc-shaped member are disposed on the base, and a radian value of the first arc-shaped member and a radian value of the second arc-shaped member are 180 degrees, the first arc-shaped member is electrically connected to a positive pole of an external power supply, and the second arc-shaped member is electrically connected to a negative pole of the external power supply, the first transfer member and the second transfer member are disposed on the drive bracket, during a rotation of the drive bracket, an end of the first transfer member remains in contact with the first arc-shaped member, and an end of the second transfer member remains in contact with the second arc-shaped member.

Optionally, the first arc-shaped member is disposed concentrically with the second arc-shaped member, and a radius dimension of the first arc-shaped member is different from a radius dimension of the second arc-shaped member.

Optionally, the first transfer member is provided with a first elastic transfer portion, and the second transfer member is provided with a second elastic transfer portion, during the rotation of the drive bracket, the first elastic transfer portion remains in contact with the first arc-shaped member, and the second elastic transfer portion remains in contact with the second arc-shaped member.

Optionally, the wire assembly further includes a first connection piece and a second connection piece, where the first connection piece is connected to a positive pole of the charging coil, the second connection piece is connected to a negative pole of the charging coil, the first connection piece is provided with a first elastic connection portion, the second connection piece is provided with a second elastic connection portion, the first transfer member includes a first strip member, the first elastic transfer portion is disposed on the first strip member, the second transfer member includes a second strip member, the second elastic transfer portion is disposed on the second strip member, during a sliding of the moving member, the first elastic connection portion remains in contact with the first strip member, and the second elastic connection remains in contact with the second strip member.

Optionally, an end of the first elastic connection portion abutting against the first strip member is provided with a first front connection arc surface structure and a first rear connection arc surface structure: and/or an end of the second elastic connection portion abutting against the second strip member is provided with a second front connection arc surface structure and a second rear connection arc surface structure.

Optionally, the base is provided with a via, the base is provided with a first arc-shaped groove and a second arc-shaped groove which communicate with the via, a radian value of the first arc-shaped groove and a radian value of the second arc-shaped groove are 180 degrees, the first arc-shaped member is disposed in the first arc-shaped groove, and the second arc-shaped member is disposed in the second arc-shaped groove.

Optionally, the wire assembly further includes a ring-shaped conductive member, a first spring contact and a second spring contact, where a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via a connection line, another end of the ring-shaped conductive member is disposed at the output end of the first drive assembly, the first spring contact is in contact with the first conductive ring, and the second spring contact is in contact with the second conductive ring.

Beneficial effects of the present disclosure are as follows.

The present disclosure provides the wireless charging apparatus, in the wireless charging apparatus, the first drive assembly and the second drive assembly are provided, the output end of the first drive assembly is rotatably movable, the second drive assembly includes the drive bracket and the moving member, the moving member is linearly movable in the extension direction of the drive bracket, the first drive assembly is disposed on the base, the drive bracket is disposed at the output end of the first drive assembly, and the charging coil is disposed in the moving member. At this time, the first drive assembly cooperates with the second drive assembly, so that the comprehensive coverage of the charging coil relative to the load-bearing cover plate may be achieved, and an issue of being stuck is avoided by using the first drive assembly as a motion assembly of a previous stage, and thus the user experience is improved.

### BRIEF DESCRIPTION OF DRAWINGS

FIG. 1 is a schematic structural diagram of a wireless charging apparatus in an embodiment of the present disclosure:

FIG. 2 is a schematic diagram of an internal structure of a wireless charging apparatus in an embodiment of the present disclosure:

FIG. 3 is an exploded diagram of a wireless charging apparatus in an embodiment of the present disclosure:

FIG. 4 is a schematic structural diagram of a second drive assembly in an embodiment of the present disclosure:

FIG. 5 is a schematic structural diagram of a moving member and a wire assembly in an embodiment of the present disclosure:

FIG. 6 is a schematic structural diagram of an ring-shaped conductive member and a first power member in an embodiment of the present disclosure; and

FIG. 7 is a schematic structural diagram of a first drive assembly and a wire assembly in an embodiment of the present disclosure.

In the drawings:
1: Housing; 11: Load-bearing cover plate;
2: Base; 21: Via; 22: Sliding chute;
3: First drive assembly; 31: Insertion pin;
4: Second drive assembly; 41: Drive bracket; 411: First support member; 412: Second support member; 42: Screw rod; 43: Moving member; 44: First power member;
5: Charging coil;
6: Wire assembly; 60: External power supply; 61: First transfer member; 611: First elastic transfer portion; 6111: First transfer arc surface structure; 612: First strip member; 62: Second transfer member; 621: Second elastic transfer portion; 6211: Second transfer arc surface structure; 622: Second strip member; 63: First arc-shaped member; 64: Second arc-shaped member; 65: First connection piece; 651: First elastic connection portion; 6511: First front connection arc surface structure; 6512: First rear connection arc surface structure; 66: Second connection piece; 661: Second elastic connection portion; 6611: Second front connection arc surface structure; 6612: Second rear connection arc surface structure; 67: Ring-shaped conductive member; 671: First conductive ring; 672: Second conductive ring; 673: Insertion slot, 674: Flexible circuit board; 68: First spring contact; 69: Second spring contact;
7: Detection assembly;
8: Control circuit board.

### DETAILED DESCRIPTION

Technical schemes of the present disclosure will be described clearly and completely below in conjunction with the drawings. Apparently, the described embodiments are part of the embodiments of the present disclosure, rather than all of the embodiments of the present disclosure. All other embodiments obtained by those of ordinary skill in the art based on the embodiments of the present disclosure without requiring creative efforts shall all fall within the scope of protection of the present disclosure.

In the description of the present disclosure, it should be noted that orientations or position relations indicated by terms such as “center”, “upper”, “lower”, “left”, “right”, “vertical”, “horizontal”, “in” and “out” are orientations or position relations shown based on the drawings.

These orientations or position relations are intended merely to facilitate and simplify the description of the present disclosure and not to indicate or imply that a device or element referred to must have such particular orientations or must be configured or operated in such particular orientations. Thus, these orientations or position relations are not to be construed as limiting the present disclosure. Moreover, terms such as “first” and “second” are used only for the purpose of description and are not to be construed as indicating or implying relative importance. The terms “first position” and “second position” are two different positions, moreover, the first feature being “on”, “above” and “over” the second feature includes the first feature being directly above and obliquely above the second feature, or simply indicates that the first feature is at a higher level than the second feature. The first feature being “under”, “below” and “beneath” the second feature includes the first feature being directly below and obliquely below the second feature, or simply represents that the first feature is at a lower level than the second feature.

In the description of the present disclosure, it should be noted that terms “mounted”, “joined” and “connected” are to be understood in a broad sense unless otherwise expressly specified and limited. For example, the term “connected” may refer to “fixedly connected” or “detachably connected” or “integrally connected”, may refer to “mechanically connected” or “electrically connected”, or may refer to “connected directly”, “connected indirectly through an intermediary” or “connected inside two elements”. For those of ordinary skill in the art, specific meanings of the preceding terms in the present disclosure may be understood based on specific situations.

The embodiments of the present disclosure will be described in detail below; examples of the above-described embodiments are shown in the accompanying drawings, where the same or similar reference numerals refer to the same or similar elements or elements having the same or similar functions throughout. The embodiments described below with reference to the accompanying drawings are exemplary and are used only for explaining the present disclosure, and should not be construed as limiting the present disclosure.

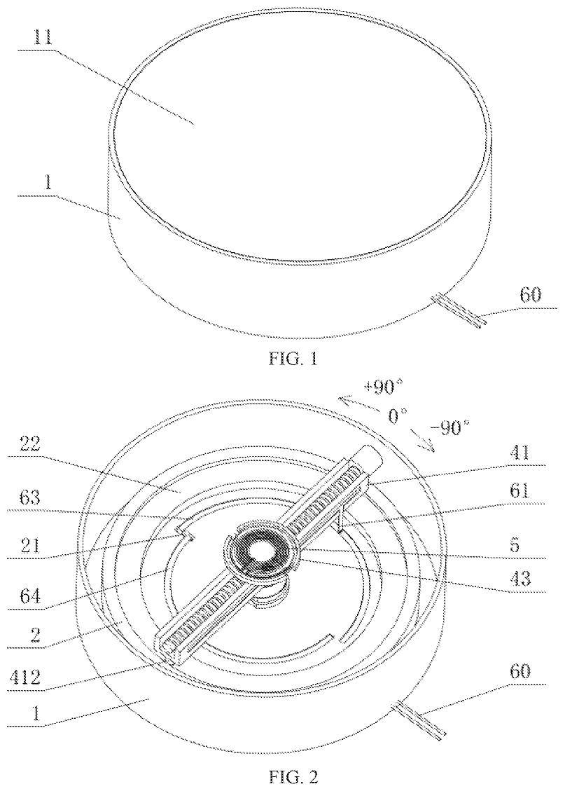

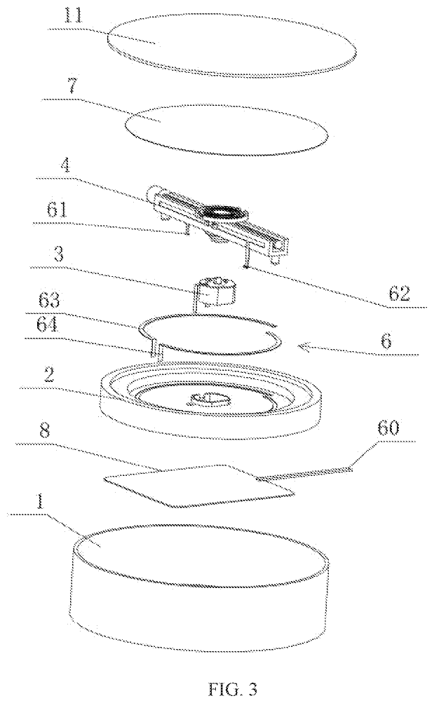

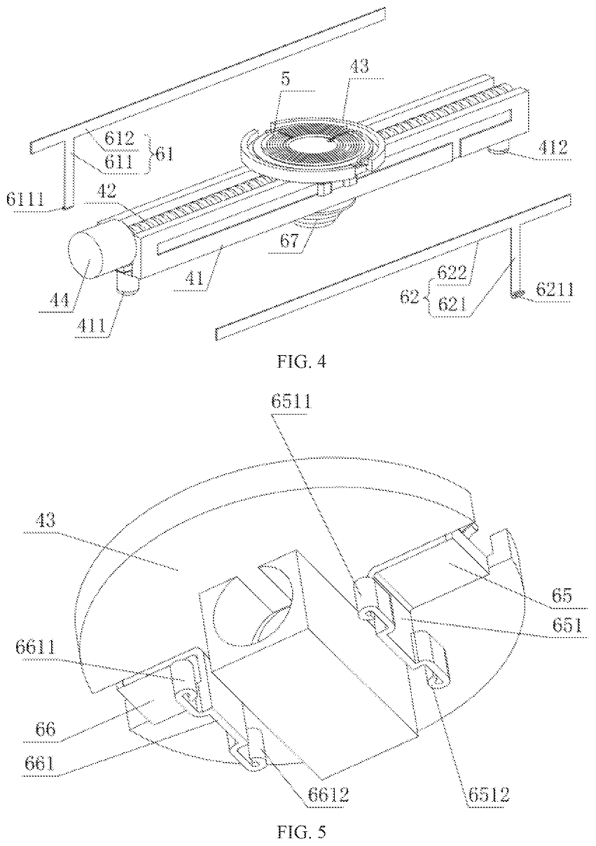

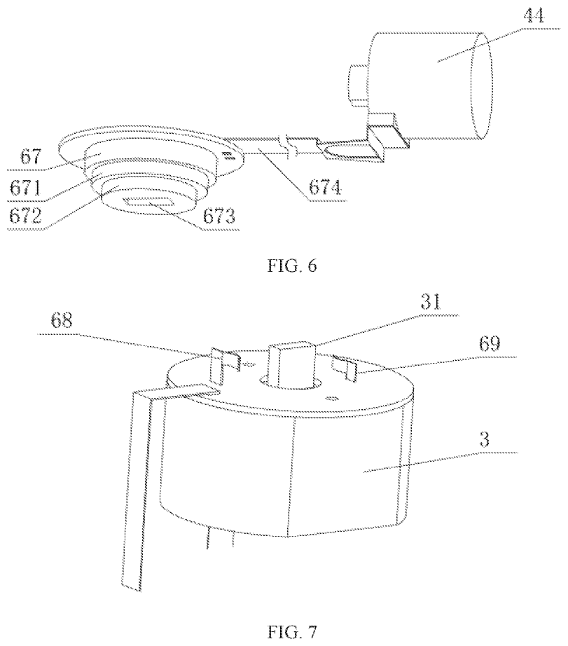

As shown in FIGS. 1 to 7, this embodiment provides a wireless charging apparatus for charging a device to be charged, in this embodiment, the device to be charged may be an electronic equipment that can be charged, such as a mobile phone, a tablet, a watch, but is not limited thereto. For ease of description, the mobile phone is used as an example for description. The wireless charging apparatus includes a housing 1, a base 2, a first drive assembly 3, a second drive assembly 4, a charging coil 5 and a wire assembly 6. The housing 1 is provided with a load-bearing cover plate 11, and the load-bearing cover plate 11 is configured to carry the mobile phone. The base 2 is disposed within the housing 1. The first drive assembly 3 is disposed on the base 2 and is configured to provide a rotational motion. The second drive assembly 4 is disposed at an output end of the first drive assembly 3 and is configured to provide a linear motion. The charging coil 5 is disposed at an output end of the second drive assembly 4 and is configured to charge the mobile phone. An input end of the wire assembly 6 is located on the base 2, one output end of the wire assembly 6 is connected to the charging coil 5, and another output end of the wire assembly 6 is connected to the second drive assembly 4.

In the wireless charging apparatus, the first drive assembly 3 and the second drive assembly 4 are provided, and the first drive assembly 3 is disposed on the base 2, the second drive assembly 4 is disposed at the output end of the first drive assembly 3, and the charging coil 5 is disposed at the output end of the second drive assembly 4. Consequently, the cooperation of the first drive assembly 3 with the second drive assembly 4 enables the charging coil 5 to comprehensively cover the load-bearing cover plate 11. Using the first drive assembly 3 as an initial stage motion assembly prevents jamming, thus enhancing the user experience.

It should be noted that the wireless charging apparatus further includes a controller and a detection assembly 7. The controller is disposed on a control circuit board 8, and the control circuit board 8 is disposed below the base 2. The detection assembly 7 is disposed above the base 2 and located below the load-bearing cover plate 11. The controller is communicatively connected to the detection assembly 7, the first drive assembly 3, the second drive assembly 4, and the charging coil 5. The detection assembly 7 is configured to detect a specific position of the mobile phone on the load-bearing cover plate 11 and transmit position information to the controller, and the controller is configured to control the first drive assembly 3 and the second drive assembly 4 to move, and is configured to control the charging coil 5 to charge the mobile phone after the charging coil 5 is moved to a corresponding position. The detection principle of the detection module 7 and the specific control principle of the controller are well known to those skilled in the art, and, hence, are not described herein.

In this embodiment, the second drive assembly 4 includes a drive bracket 41, a screw rod 42, a moving member 43 and a first power member 44. The drive bracket 41 is rotatably disposed at the output end of the first drive assembly 3. The screw rod 42 is rotatably disposed on the drive bracket 41. The first power member 44 is disposed on the drive bracket 41 and is in transmission connection with the screw rod 42. The moving member 43 is provided with a screw hole, and the moving member 43 is slidably disposed on the drive bracket 41 and is in threaded engagement with the screw rod 42. The charging coil 5 is disposed in the moving member 43. The moving member 43 is provided with a coil slot, and the charging coil 5 is placed in the coil slot. The first power member 44 may be a step motor. The cooperation of the screw rod 42 and the moving member 43 allows for precise control of the position of the charging coil 5, and the cooperation of the screw rod 42 and the screw hole has a self-locking function. When the charging coil 5 charges the mobile phone, the first power member 44 can be switched off, and the charging coil 5 will not be displaced, reducing energy consumption.

To prevent the wire from bending or even breaking during movement, thereby affecting conductivity, in this embodiment, the wire assembly 6 Optionally comprises a first transfer member 61, a second transfer member 62, a first arc-shaped member 63 and a second arc-shaped member 64. Both the first arc-shaped member 63 and the second arc-shaped member 64 are disposed on the base 2, and both have a radian value of 180 degrees. The first arc-shaped member 63 and the second arc-shaped member 64 are electrically connected to an external power supply 60, the first arc-shaped member 63 and the second arc-shaped member 64 are connected to a positive pole and a negative pole of the external power supply 60, respectively.

The first arc-shaped member 63 is electrically connected to the positive pole of the external power supply 60, and the second arc-shaped member 64 is electrically connected to the negative pole of the external power supply 60. The first transfer member 61 and the second transfer member 62 are disposed on the drive bracket 41, the first transfer member 61 is provided with a first elastic transfer portion 611, and the second transfer member 62 is provided with a second elastic transfer portion 621. During the rotation of the drive bracket 41, the first elastic transfer portion 611 maintains contact with the first arc-shaped member 63, and the second elastic transfer portion 621 remains in contact with the second arc-shaped member 64. This arrangement eliminates the wire structure and prevents bending or even breaking of the wire during rotation of the drive bracket 41, thereby improving the conductivity and enhancing the stability of the wireless charging apparatus.

The first arc-shaped member 63 is of a conductive material, Optionally of a copper material. The second arc-shaped member 64 is of a conductive material, Optionally of a copper material. The first transfer member 61 is of a conductive material, Optionally of a copper material. The second transfer member 62 is of a conductive material, Optionally of a copper material. The first elastic transfer portion 611 has a sheet-shaped structure, and extends from the first transfer member 61 to the first arc-shaped member 63. The first elastic transfer portion 611 has a slight curvature in a process of contacting the first arc-shaped member 63, and has a curved shape so as to always maintain in contact with the first arc-shaped member 63. The second elastic transfer portion 621 has a sheet-shaped structure and extends from the second transition member 62 to the second arc-shaped member 64. The second elastic transfer portion 621 has a slight curvature in a process of being in contact with the second arc-shaped member 64, and has a curved shape so as to always maintain in contact with the second arc-shaped member 64.

In addition, the radian value of the first arc-shaped member 63 and the radian value of the second arc-shaped member 64 in this embodiment are each set to be 180 degrees, so that the drive bracket 41 may rotate between +90 degrees and −90 degrees, where 0 degree is located in an intermediate position.

In this embodiment, the first arc-shaped member 63 is disposed concentrically with the second arc-shaped member 64, and a radius dimension of the first arc-shaped member 63 is different from a radius dimension of the second arc-shaped member 64. Through the above-described arrangement, when a rotation angle of the drive bracket 41 exceeds 90 degrees, the first elastic transfer portion 611 is disconnected from the first arc-shaped member 63, and the second elastic transfer portion 621 is disconnected from the second arc-shaped member 64. Since a radius of the first arc-shaped member 63 is different from a radius of the second arc-shaped member 64, so that the first elastic transfer portion 611 is not connected to the second arc-shaped member 64, and the second elastic transfer portion 621 is not connected to the first arc-shaped member 63. This arrangement prevents an electrode inversion in the charging coil 5, thereby enhancing the safety of the wireless charging apparatus.

In order to achieve a reliable electrical connection, in a first implementation of this embodiment, an end of the first elastic transfer portion 611 abutting against the first arc-shaped member 63 is provided with a first transfer arc surface structure 6111. In a second implementation of this embodiment, an end of the second elastic transfer portion 621 abutting against the second arc-shaped member 64 is provided with a second transfer arc surface structure 6211. In a third implementation of this embodiment, an end of the first elastic transfer portion 611 abutting against the first arc-shaped member 63 is provided with a first transfer arc surface structure 6111, and an end of the second elastic transfer portion 621 abutting against the second arc-shaped member 64 is provided with a second transfer arc surface structure 6211. The first transfer arc surface structure 6111 is provided so that during the rotation of the drive bracket 41, the contact between the first elastic transfer portion 611 and the first arc-shaped member 63 is more smooth, and the occurrence of sticking is avoided. The first transfer arc surface structure 6111 is formed by bending an end of the first elastic transfer portion 611 facing the first arc-shaped member 63. The second transfer arc surface structure 6211 is provided so that during the rotation of the drive bracket 41, the contact between the second elastic transfer portion 621 and the second arc-shaped member 64 is more smooth, and the occurrence of sticking is avoided. The second transfer arc surface structure 6211 is formed by bending an end of the second elastic transfer portion 621 facing the second arc-shaped member 64. Of course, in other embodiments, both the first elastic transfer portion 611 and the second elastic transfer portion 621 may be replaced by a carbon brush.

The base 2 is provided with a via 21, and the base 2 is provided with a first arc-shaped groove and a second arc-shaped groove which communicate with the via 21, a radian value of the first arc-shaped groove and a radian value of the second arc-shaped groove are 180 degrees, the first arc 63 is disposed in the first arc-shaped groove, and the second arc-shaped member 64 is disposed in the second arc-shaped groove. In this embodiment, a positive cable passes through the via 21 and is connected to the first arc-shaped member 63, and a negative cable passes through the via 21 and is connected to the second arc-shaped member 64. In addition, the first arc-shaped member 63 and the second arc-shaped member 64 each have a sheet-shaped structure, and are disposed in the first arc-shaped groove and the second arc-shaped groove, respectively, so that the material consumption is low and the cost is low:

The wire assembly 6 includes a first connection piece 65 and a second connection piece 66, where the first connection piece 65 is connected to a positive terminal of the charging coil 5, the second connection piece 66 is connected to a negative terminal of the charging coil 5, the first connection piece 65 is provided with a first elastic connection portion 651, the second connection piece 66 is provided with a second elastic connection portion 661, the first transfer member 61 includes a first strip member 612, the first elastic transfer portion 611 is disposed on the first strip member 612, the second transfer member 62 includes a second strip member 622, the second elastic transfer portion 621 is disposed on the second strip member 622. During a sliding of the moving member 43, the first elastic connection portion 651 remains in contact with the first strip member 612, and the second elastic connection portion 661 remains in contact with the second strip member 622. Through the above-described arrangement, the provision of the wire between the charging coil 5 and the first transfer member 61 and the second transfer member 62 is avoided, a condition that the wire is bent and even broken during the sliding of the moving member 41 to affect the conductive effect is avoided, and thus the stability of the wireless charging apparatus is improved.

In order to achieve a reliable electrical connectivity, in the first implementation of this embodiment, an end of the first elastic connection portion 651 abutting against the first strip member 612 is provided with a first front connection arc surface structure 6511 and a first rear connection arc surface structure 6512. In the second implementation of this embodiment, an end of the second elastic connection portion 661 abutting against the second strip member 622 is provided with a second front connection arc surface structure 6611 and a second rear connection arc surface structure 6612. In the third implementation of this embodiment, an end of the first elastic connection portion 651 abutting against the first strip member 612 is provided with a first front connection arc surface structure 6511 and a first rear connection arc surface structure 6512, and an end of the second elastic connection portion 661 abutting against the second strip member 622 is provided with a second front connection arc surface structure 6611 and a second rear connection arc surface structure 6612. The first front connection arc surface structure 6511 and the first rear connection arc surface structure 6512 are provided so that during the rotation of the moving member 43, the contact between the first elastic connection portion 651 and the first strip member 612 is more smooth, and the occurrence of sticking is avoided. The first front connection arc surface structure 6511 and the first rear connection arc surface structure 6512 are located on a front side and a rear side of the end of the first elastic connection portion 651 abutting against the first strip member 612, that is, the first front connection arc surface structure 6511 is located on the front side of the end of the first elastic connection portion 651 abutting against the first strip member 612, and the first rear connection arc surface structure 6512 is located on the rear side of the end of the first elastic connection portion 651 abutting against the first strip member 612. A first front piece and a first rear piece are disposed on a front side and a rear side of an end of the first elastic connection portion 651 facing the first strip member 612, respectively, that is, the first front piece is disposed on the front side of the end of the first elastic connection portion 651 facing the first strip member 612, and the first rear piece is disposed on the rear side of the end of the first elastic connection portion 651 facing the first strip member 612, and the first front connection arc surface structure 6511 is formed by bending the first front piece. The first rear connection arc surface structure 6512 is formed by bending the first rear piece. Similarly, the second front connection arc surface structure 6611 and the second rear connection arc surface structure 6612 are provided so that during the rotation of the moving member 43, the contact between the second elastic connection portion 661 and the second strip member 622 is more smooth, and the occurrence of sticking is avoided. Here, with respect to structures of the second front connection arc surface structure 6611 and the second rear connection arc surface structure 6612, similarly, the second front connection arc surface structure 6611 and the second rear connection arc surface structure 6612 are located on a front side and a rear side of an end of the second elastic connection portion 661 abutting against the second strip member 622. A front side and a rear side of an end of the second elastic connection portion 661 facing the second strip member 622 are provided with a second front piece and a second rear piece, respectively. The second front connection arc surface structure 6611 is formed by the second front piece, and the second rear connection arc surface structure 6612 is formed by bending the second rear piece. Of course, in other embodiments, both the first elastic connection portion 651 and the second elastic connection portion 661 may be replaced by a carbon brush.

Optionally: the drive bracket 41 is provided with a first mounting groove and a first lead-out groove communicating with the first mounting groove, the first strip member 612 is sheet-shaped and mounted in the first mounting groove, the first elastic transfer portion 611 has a sheet-shaped structure, and the first elastic transfer portion 611 is mounted in the first lead-out groove. As a whole, the first transfer member 61 has a sheet-shaped structure and is L-shaped. The drive bracket 41 is provided with a second mounting groove and a second lead-out groove communicating with the second mounting groove, the second strip member 622 is sheet-shaped and mounted in the second mounting groove, the second elastic transfer portion 621 has a sheet-shaped structure, and the second elastic transfer portion 621 is mounted on the second lead-out groove. As a whole, the second transfer member 62 has a sheet-shaped structure and is L-shaped.

The drive bracket 41 is provided with a first support member 411 and a second support member 412 at intervals, the base 2 is provided with a sliding chute 22, and the first support member 411 and the second support member 412 are disposed in the sliding chute 22. Specifically, the first support member 411 and the second support member 412 are respectively disposed at two ends of the drive bracket 41, the sliding chute 22 is ring-shaped, and the first support member 411 and the second support member 412 may slide in the sliding chute 22. Optionally, the first support member 411 and the second support member 412 may be of a slider structure. In other embodiments, and an end of each of the first support member 411 and second support member 412 contacting with the sliding chute 22 may be provided with a roller.

The sliding chute 22 is provided with a stop portion, and the stop portion is configured to abut against the first support member 411 and the second support member 412, to limit a rotation angle of the drive bracket 41. Optionally, one stop portion is provided, the first support member 411 abuts against the stop portion when the drive bracket 41 rotates +90, and the second support member 412 abuts against the stop portion when the drive bracket 41 rotates −90.

In this embodiment, the first drive assembly 3 includes a rotation motor, the rotation motor is disposed on the base 2, and the second drive assembly 4 is disposed at an output end of the rotation motor. The rotation motor may be a step motor, through this arrangement, the drive bracket 41 may be rotated at any angle. Of course, in other embodiments, the first drive assembly 3 may further include a push rod motor, a rack, and a gear, where the push rod motor is disposed on the base 2, and the rack is slidably disposed on the base 2 and is in transmission connection with the push rod motor, and the gear is rotatably disposed on the base 2 and is in mesh with the rack, in this embodiment, and the drive bracket 41 is disposed on the gear.

The wire assembly 6 includes a first rotation circuit board, a second rotation circuit board, a ring-shaped conductive member 67, a first spring contact 68, and a second spring contact 69. The positive pole and the negative pole of the external power supply 60 may be communicated to the first rotation circuit board, the first rotation circuit board is disposed on the top of the rotation motor, the first spring contact 68 and the second spring contact 69 are disposed on the first rotation circuit board and are communicated with the positive pole and the negative pole of the external power supply 60, the second rotation circuit board is disposed on the drive bracket 41, the ring-shaped conductive member 67 is provided with a first conductive ring 671 and a second conductive ring 672 which are insulated from each other and are disposed at an interval from top to bottom, an end of the ring-shaped conductive member 67 is fixed to the second rotation circuit board, the second rotation circuit board is fixed to the drive bracket 41, another end of the ring-shaped conductive member 67 is fixed to the output end of the rotation motor, during a rotation of the ring-shaped conductive member 67, the first spring contact 68 remains in contact with the first conductive ring 671, the second spring contact 69 remains in contact with the second conductive ring 672, so that the first spring contact 68 is slidably disposed at a periphery of the first conductive ring 671, and the second spring contact 69 is slidably disposed at a periphery of the second conductive ring 672. Both the first conductive ring 671 and the second conductive ring 672 transmit electricity to the first rotation circuit board through the cable, and the first rotation circuit board may supply power to the first power member 44. An end of the ring-shaped conductive member 67 is provided with an insertion slot 673, and the output end of the rotation motor is provided with an insertion pin 31, and the insertion pin 31 and the insertion slot 673 are inserted and matched. A cross section of the insertion pin 31 is non-circular, and a shape of the insertion slot 673 is adapted to match the insertion pin 31. Optionally, a cross section of insertion pin 31 is square, and a shape of the insertion slot 673 is also square. Through the arrangement, during the rotation, the first spring contact 68 and the second spring contact 69 may abut against the first conductive ring 671 and the second conductive ring 672, respectively, to transmit electricity from the first rotation circuit board to the rotating second rotation circuit board, which may in turn be transmitted to the first power member 44 through a wire or a flexible circuit board 674. Of course, in other embodiments, the power of the first power member 44 may be supplied through the first transfer member 61 and the second transfer member 62.

In this embodiment, optionally, a length dimension of the insertion pin 31 is greater than a depth dimension of the insertion slot 673, and the insertion pin 31 may abut against a slot bottom of the insertion slot 673, so as to ensure that no friction occurs between the first rotation circuit board and the second rotation circuit board.

What is claimed is:

1. A wireless charging apparatus, comprising:
a housing, wherein the housing is provided with a load-bearing cover plate, and the load-bearing cover plate is configured to carry a device to be charged;
a base, wherein the base is disposed within the housing;
a first drive assembly, wherein the first drive assembly is disposed on the base;
a second drive assembly, wherein the second drive assembly comprises a drive bracket and a moving member, wherein the drive bracket is disposed at an output end of the first drive assembly, the output end of the first drive assembly is capable of performing a rotary motion, and the moving member is capable of performing a linear motion along an extension direction of the drive bracket; and
a charging coil, wherein the charging coil is disposed in the moving member.

2. The wireless charging apparatus of claim 1, wherein the second drive assembly comprises the drive bracket, a screw rod, the moving member and a first power member, wherein the drive bracket is rotatably disposed at the output end of the first drive assembly, the screw rod is rotatably disposed on the drive bracket, the first power member is disposed on the drive bracket and is in transmission connection with the screw rod, the moving member is provided with a screw hole, and the moving member is slidably disposed on the drive bracket and is in threaded engagement with the screw rod.

3. The wireless charging apparatus of claim 1, further comprising a wire assembly, an input end of the wire assembly is located on the base, and an output end of the wire assembly is connected to the charging coil.

4. The wireless charging apparatus of claim 3, wherein the wire assembly comprises a first transfer member, a second transfer member, a first arc-shaped member and a second arc-shaped member, wherein the first arc-shaped member and the second arc-shaped member are disposed on the base, and a radian value of the first arc-shaped member and a radian value of the second arc-shaped member are 180 degrees, the first arc-shaped member is electrically connected to a positive pole of an external power supply, and the second arc is electrically connected to a negative pole of the external power supply, the first transfer member and the second transfer member are disposed on the drive bracket, during a rotation of the drive bracket, an end of the first transfer member remains in contact with the first arc-shaped member, and an end of the second transfer member remains in contact with the second arc-shaped member.

5. The wireless charging apparatus of claim 4, wherein the first arc-shaped member is disposed concentrically with the second arc-shaped member, and a radius dimension of the first arc-shaped member is different from a radius dimension of the second arc-shaped member.

6. The wireless charging apparatus of claim 4, wherein the first transfer member is provided with a first elastic transfer portion, and the second transfer member is provided with a second elastic transfer portion, during the rotation of the drive bracket, the first elastic transfer portion remains in contact with the first arc-shaped member, and the second elastic transfer portion remains in contact with the second arc-shaped member.

7. The wireless charging apparatus of claim 6, wherein the wire assembly further comprises a first connection piece and a second connection piece, wherein the first connection piece is connected to a positive pole of the charging coil, the second connection piece is connected to a negative pole of the charging coil, the first connection piece is provided with a first elastic connection portion, the second connection piece is provided with a second elastic connection portion, the first transfer member comprises a first strip member, the first elastic transfer portion is disposed on the first strip member, the second transfer member comprises a second strip member, the second elastic transfer portion is disposed on the second strip member, during a sliding of the moving member, the first elastic connection portion remains in contact with the first strip member, and the second elastic connection remains in contact with the second strip member.

8. The wireless charging apparatus of claim 7, wherein an end of the first elastic connection portion abutting against the first strip member is provided with a first front connection arc surface structure and a first rear connection arc surface structure; and/or
wherein an end of the second elastic connection portion abutting against the second strip member is provided with a second front connection arc surface structure and a second rear connection arc surface structure.

9. The wireless charging apparatus of claim 4, wherein the base is provided with a via, the base is provided with a first arc-shaped groove and a second arc-shaped groove which communicate with the via, a radian value of the first arc-shaped groove and a radian value of the second arc-shaped groove are 180 degrees, the first arc-shaped member is disposed in the first arc-shaped groove, and the second arc-shaped member is disposed in the second arc-shaped groove.

10. The wireless charging apparatus of claim 3, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.

11. The wireless charging apparatus of claim 4, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.

12. The wireless charging apparatus of claim 5, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.

13. The wireless charging apparatus of claim 6, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.

14. The wireless charging apparatus of claim 7, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.

15. The wireless charging apparatus of claim 8, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.

16. The wireless charging apparatus of claim 9, wherein the wire assembly further comprises a ring-shaped conductive member, a first spring contact and a second spring contact, wherein a positive pole of the external power supply is communicated with the first spring contact, a negative pole of the external power supply is communicated with the second spring contact, the first spring contact and the second spring contact are both located at the output end of the first drive assembly, the ring-shaped conductive member is provided with a first conductive ring and a second conductive ring which are insulated from each other, an end of the ring-shaped conductive member is disposed on the second drive assembly, both the first conductive ring and the second conductive ring supply power to the second drive assembly via connection lines, another end of the ring-shaped conductive member is disposed at the output end of the first drive assembly, the first spring contact is in contact with the first conductive ring, and the second spring contact is in contact with the second conductive ring.
